(19) United States
(12) Patent Application Publication
(10) Pub. No.: US 2023/0262036 A1
(43) Pub. Date: Aug. 17, 2023

(54) CONTINUOUS ENCRYPTION FUNCTIONS FOR SECURITY OVER NETWORKS

(71) Applicant: The Regents of the University of California, Oakland, CA (US)

(72) Inventor: Yingbo HUA, Riverside, CA (US)

(73) Assignee: The Regents of the University of California, Oakland, CA (US)

(21) Appl. No.: 17/974,422

(22) Filed: Oct. 26, 2022

Related U.S. Application Data
(60) Provisional application No. 63/273,392, filed on Oct. 29, 2021.

(51) Int. Cl. H04L 9/40; H04W 12/03

(52) U.S. Cl. CPC H04L 63/0485; H04W 12/03

(57) ABSTRACT

A communication network may comprise: a first communication node configured for, based on a first association with a vector, encrypting information to be transmitted; a transmitter circuitry configured for transmitting the encrypted information; a receiver circuitry configured for receiving the transmitted encrypted information; a second communication node configured for, based on a second association with the vector, decrypting the received encrypted information. The vector may be a physical-layer feature vector or a common feature vector. The encryption and decryption may be based on linear or nonlinear encryption functions. A nonlinear encryption function may have an output that is based on a singular value decomposition of an input. The encryption and decryption may apply to security over networks, including for wireless communications or biometric templates.

### CROSS REFERENCE TO RELATED APPLICATIONS

This application claims priority to U.S. Provisional Application Ser. No. 63/273,392, filed Oct. 29, 2021, which is hereby incorporated herein by reference in its entirety.

### GOVERNMENT LICENSE RIGHTS

This invention was made with government support under Contract/Grant No. W911NF-17-1-0581 awarded by the Army Research Office. The government has certain rights in the invention.

### FIELD

The present disclosure relates to encryption and decryption of information. More specifically, this disclosure relates to encryption and decryption for security over networks. The security may apply to wireless communications or biometric templates.

### BACKGROUND

### I. Introduction

Continuous encryption functions (CEF) are important for security over networks using secret physical-layer feature vectors. Specific applications of CEF include the recently proposed physical layer encryption of wireless communications [1]421 and the widely known biometric template security for online Internet applications [3]441.

### SUMMARY

In some aspects, provided herein are continuous encryption functions (CEF) of secret feature vectors for security over networks, including physical layer encryption for wireless communications and biometric template security for online Internet applications. Several prior CEF-related functions such as dynamic random projection and index-of-max hashing are considered, and efficient algorithms to attack these functions are presented. Also provided herein is a new family of CEF based on selected components of singular value decomposition (SVD) of a randomly modulated matrix of a feature vector. The SVDCEF is shown not only to be hard to invert but also to have other important properties that should be expected from CEF.

In certain aspects, disclosed are communication networks, communication nodes, related circuitry, and methods involving encryption and decryption of information. A communication network may comprise: a first communication node configured for, based on a first association with a vector, encrypting information to be transmitted; a transmitter circuitry configured for transmitting the encrypted information; a receiver circuitry configured for receiving the transmitted encrypted information; a second communication node configured for, based on a second association with the vector, decrypting the received encrypted information.

The vector may be a physical-layer feature vector x. The first association with the vector may be a first estimate x_{A} of the physical-layer feature vector x. The first communication node may be configured for, based on the first estimate x_{A}, encrypting the information to be transmitted. The second association with the vector may be a second estimate x_{B} of the physical-layer feature vector x. The second communication node may be configured for, based on the second estimate x_{B}, decrypting the received encrypted information.

The first communication node may be configured for, based on the first estimate x_{A}, performing physical layer encrypting of information to be transmitted over wireless communications. The second communication node may be configured for, based on the second estimate x_{B}, performing physical layer decrypting of the encrypted information received over wireless communications. The encrypted information may be in a quantized form. The decrypted information may be in a quantized form. The vector may be a secret physical-layer feature vector.

The first communication node may be configured for, based on a linear encryption function, encrypting the information to be transmitted. The linear encryption function may be based on a secret key S that has a large number N_{S} of binary bits in the secret key S. The linear encryption function may be based on a composite key S that is based on an external key Se and a key Sₓ generated from the vector.

The vector may be a common feature vector. The first association with the vector may be a first observation x of the common feature vector. The first communication node may be configured for, based on the first observation x, encrypting the information to be transmitted. The second association with the vector may be a second observation x′ of the common feature vector. The second communication node may be configured for, based on the second observation x′, decrypting the received encrypted information. The linear encryption function may be based on a secret key S based on the first observation x and the second observation x′.

The first communication node may be configured for, based on a nonlinear encryption function, encrypting the information to be transmitted. The nonlinear encryption function may have an output that is based on a singular value decomposition of an input. The input may be an input vector x, M_{k,x}, may be a matrix, for index k, comprising elements that result from a random modulation of the input vector x, the output may be an output vector y, and individual elements of the output vector y may be based on a component of the singular value decomposition of M_{k,x} for a value of the index k.

The first communication node may be configured for executing an algorithm to determine the nonlinear encryption function based on a singular value decomposition. The second communication node may be configured for executing the algorithm to determine the nonlinear encryption function based on a singular value decomposition.

A communication node may comprise: an encryption circuitry configured for, based on an association with a vector, encrypting information to be transmitted; a transmitter circuitry configured for transmitting the encrypted information. The communication node may be configured for, based on a nonlinear encryption function, encrypting the information to be transmitted. The nonlinear encryption function may have an output that is based on a singular value decomposition of an input.

A communication node may comprise: a receiver circuitry configured for receiving encrypted information; a decryption circuitry configured for, based on an association with a vector, decrypting the received encrypted information. The communication node may be configured for, based on a nonlinear encryption function, decrypting the received encrypted information. The nonlinear encryption function may have an output that is based on a singular value decomposition of an input.

A method may comprise: encrypting, based on a first association with a vector, information to be transmitted; transmitting the encrypted information; receiving the transmitted encrypted information; and decrypting, based on a second association with the vector, the received encrypted information.

### BRIEF DESCRIPTION OF DRAWINGS

The present application can be understood by reference to the following description taken in conjunction with the accompanying figures.

FIG. 1 illustrates the mean and mean-plus-deviation of η_{k,x} versus N.

FIG. 2 illustrates the means (lower three curves) and means-plus-deviations (upper three curves) of

$$\frac{‖ Δ \dot{{u}_{k}} ‖}{‖ Δ x ‖}$$

subject to η_{k,x}<2.5.

FIG. 3 illustrates the means and means±deviation of ρₖ (using SVD-CEF output) and ρ*ₖ (using random output) versus N subject to η_{k,x}<2.5.

FIG. 4 illustrates the means and means±deviation of D_{k,v} versus N subject to η_{k,x}<2.5.

### DETAILED DESCRIPTION OF THE INVENTION

In the following description of examples and embodiments, reference is made to the accompanying drawings which form a part hereof, and in which it is shown by way of illustration specific examples that can be practiced. It is to be understood that other examples can be used and structural changes can be made without departing from the scope of the disclosed examples.

The notions of CEF are closely related to those of the so-called continuous one-way functions, continuous noninvertible transforms, etc., in the literature. A mapping is referred to as y=ƒ(x) from x∈R^{N} to y∈R^{M}a CEF if it has all of the following properties:

1) Continuous: the output vector y is a continuous function, or at least almost always locally continuous function, of the input vector x such that a small perturbation in x almost always leads to a small perturbation in y.

2) Hard-to-invert: Computing x from y is not feasible to date within a complexity order that is a polynomial function of N and M.

3) Weak correlation: All entries of y for any M≥2 are pseudo-random so that any part of y has a near-zero correlation with any other part of y and with x.

4) Hard-to-substitute: y cannot be written as y=ƒ₁(ƒ₂(x)) where ƒ₁ is not a hard-to-invert function, ƒ₂ is a fixed (non-pseudo-random) function of x, and/or ƒ₂ has a non-trivially smaller dimension than x. Then, ƒ₂(x) is referred to as a substitute-input of the function.

5) Entropy-preserving: Subject to zero secret (other than x) in the function and a common scheme of quantization on both x and y, the entropy of the quantized y is close to that of the quantized x.

The continuous property of CEF is to ensure that y is not overly sensitive to small perturbations in x. For physical layer encryption of wireless communications, nodes A and B have their respective estimates x_{A} and x_{B} of a secret physical-layer feature vector x (such as a reciprocal channel vector between the nodes). Node A uses y_{A}=ƒ(x_{A}) to encrypt the information to be transmitted, and Node B uses y_{B}=ƒ(x_{B}) to decrypt the information to be received. For a good performance of physical layer encryption, the mean and deviation of ∥Y_{A}-y_{B}∥ should not be far from those of ∥x_{A}-x_{B}∥ especially when the latter is small. For biometric template security, the output y of the function is typically quantized (if not already in quantized form) to form cancellable biometric templates. The continuity of y with respect to x is necessary to have some robustness against small perturbations in the measurements of x (such as fingerprint and iris features) at different times.

The hard-to-invert and weak-correlation properties of CEF are to augment the overall secrecy by adding a computational-based secrecy to the information-theoretic secrecy, the latter of which comes from the secret x. For physical layer encryption of wireless communications, this means that y with arbitrary M can be used to protect computationally a large amount of transmitted information, which could be much larger than the mutual information between x_{A} and x_{B}. For biometric template security, this means that any exposed biometric templates can be simply cancelled and new biometric templates can be always generated from a (secret) measurement of the secret feature x.

The hard-to-substitute property of CEF is particularly important for biometric template security where biometric templates are often transmitted over networks. The knowledge of the existence of an easier-to-find substitute-input ƒ₂(x) would allow an adversary to determine ƒ₂(x) based on some previously exposed biometric templates, which can be then used to determine all future biometric templates based on ƒ₂(x). This property of CEF is also important for physical layer encryption because if the substitute-input ƒ₂(x) has a non-trivially smaller dimension than the original input x, then ƒ₂(x) is always easier to compute than x by exhaustive search based on a sufficient amount of exposed parts of y.

The entropy-preserving property of CEF is to preserve the information-theoretic secrecy. There are functions that may appear hard to invert but do not preserve the entropy. For example, if the variance of each element in y (in the absence of additional secret key or secrecy) is substantially smaller than the variance of each element in x, then we have a function which does not have the entropy-preserving property. Note that since y is a function of x, the entropy of y is always upper bounded by that of x.

Generally, the CEF-related functions currently known in the literature exploit some existing secret key S (as the seed) to produce pseudo-random numbers or operations needed in the functions. The (computational) complexity to invert or attack a CEF can be generally expressed as C_{N,M}2^{NS}, where N_{S} is the number of binary bits in the secret key, and C_{N,M} is the complexity to invert the CEF if the secret key is exposed. Unless mentioned otherwise, C_{N,M} refers to the complexity of attack. The understanding of C_{N,M} is important for situations where N_{S} is not sufficiently large.

As explained herein, for the random projection (RP) method [5], the dynamic random projection (DRP) method [6] and the Index-of-Maximum (IoM) hashing algorithm 1 [8], C_{N,M}=PNM where PNM is a polynomial function of both N and M. Also shown is that for the IoM algorithm 2 in [8], C_{N,M}=P_{N,M} where P_{N,M} with PNM being a linear function of N and M respectively. The complexity factor 2^{N} against attack can be achieved in a much easier way.

Another major contribution herein is a new family of nonlinear CEF called SVD-CEF. This family of CEF is based on the use of components of singular value decomposition (SVD) of a randomly modulated matrix of x. Like IoM in [8], SVD-CEF falls into the nonlinear family of CEF, which is in contrast to the linear family of CEF such as RP and DRP in [5] and [6]. Based on the current knowledge, the complexity order to attack a SVD-CEF is C_{N,M}=P_{N,M}2^{ζN} where ζ is typically much larger than one and increases as N increases.

In section II below, a linear family of CEF, including random projection (RP) and dynamic random projection (DRP) is explored. Both RP and DRP without a secret key is shown to be successfully attacked with a polynomial complexity. Discussed herein is also the usefulness of unitary random projection, a useful transformation from the N-dimensional real space R^{N} to the N-dimensional sphere of unit radius S^{N}(1), and a simple method for secret key generation useful to enhance the hardness-to-invert of any simple CEF. In section III below, we review a family of nonlinear CEF, including higher-order polynomials (HOP) and Index-of-Max (IoM) hashing functions, is also explored. HOP is not hard to substitute, IoM algorithm 1 can be attacked with a polynomial complexity, and IoM algorithm 2 can be attached with a complexity equal to P_{N,M}2^{N}. In section IV below, presented is also a new family of nonlinear CEF called SVD-CEF, which is a new development from our prior works in [1]-[2]. In section V, provided is a strong reason why SVDCEF is hard to substitute and hard to invert. In section VI, provided is also statistical analyses and simulation results to show how robust the output of SVD-CEF is to perturbations in the input and why the output of SVD-CEF has the weak-correlation and entropy-preserving properties. The conclusion is given in section VII.

### II. LINEAR FAMILY OF CEF

A family of linear CEF can be expressed as follows:

y=R_{S}x (1)

where R_{S} is a pseudo-random matrix dependent on a secret key S. The ith subvector of y can be written as

yᵢ=R_{S,i}x (2)

where yᵢ∈R_{Mi}, R_{Si}∈R_{Mi×N} and x∈R_{N}.

A. Random Projection

The linear family of CEF includes the random projection (RP) method shown in [5] and applied in [9]. If S is known, so is R_{S,i} for all i. If yᵢ for some i is known/exposed and R_{S,i} is of the full column rank N, then x is given by R_{S,i}⁺yᵢ=(R^{T}_{S,i}R_{S,i})⁻¹R^{T}_{S,i}y₁ where ⁺ denotes pseudo-inverse. If R_{S,i} is not of full column rank, then x can be computed from a set of outputs like (for example) y₁, . . . , y_{L} where L is such that the vertical stack of R_{S,1}, . . . , R_{S,L}, denoted by R_{S,1:L}, is of the full column rank N. If S is unknown, then a method to compute x includes a discrete search for the N_{S} bits of S as follows

$${min}_{S} {min}_{x} ‖ {y}_{1 : L} - {R}_{S , 1 : L} x ‖ = {min}_{S} ‖ {y}_{1 : L} - {R}_{S , 1 : L} {R}_{S , 1 : L}^{+} {y}_{1 : L} ‖ \qquad ( 3 )$$

where y_{1:L} is the vertical stack of y₁, . . . , y_{L}. The total complexity of the above attack algorithm with unknown key S is P_{N,M}2^{NS} with PNM being a linear function of Σ^{L}ᵢ₌₁ Mᵢ and a cubic function of N.

So, RP is not secure unless there is a strong secret key S (with a large N_{S}).

B. Dynamic Random Projection

The dynamic random projection (DRP) method proposed in [6] and also discussed in [4] can be described by

yᵢ=R_{S,i,x}X (4)

where R_{S,i,x} is the ith realization of a random matrix that depends on both S and x. Since R_{S,i,x} is discrete, yᵢ in (4) is a locally linear function of x. (There is a nonzero probability that a small perturbation w in x′=x+w leads to R_{S,i,x}, being substantially different from R_{S,i,x}. This is not a desirable outcome for biometric templates although the probability may be small.) Two methods were proposed in [6] to construct R_{S,i,x}, which were called “Functions I and II” respectively. For simplicity of notation, i and S are suppressed in (4) and are written as

y=Rₓx (5)

1) Assuming “Function I” in [6]: In this case, the ith element of y, denoted by vᵢ, corresponds to the ith slot shown in [6] and can be written as

vᵢ=r^{T}_{x,i}x (6)

where r^{T}_{x,i} is the ith row of Rₓ. But r^{T}_{x,i} is one of L key-dependent pseudo-random vectors r^{T}_{i,1}, . . . , r^{T}_{i,L} that are independent of x and known if S is known. So it can also be written as where r

vᵢ=r^{T}ᵢx̅ (7)

where rᵢ^{T}=[r_{i,1}^{T}, . . . , r_{i.L}^{T}]^{T}, and x̅∈R^{LN} is a sparse vector consisting of zeros and x. Before x is known, the position of x in x̅ is initially unknown.

If an attacker has stolen K realizations of vᵢ (denoted by v_{i,1}, . . . , v_{i,K}), then it follows that

vᵢ=Rᵢx̅ (8)

where vᵢ=[v_{i,1}, . . . , V_{i,K}]^{T}, and Rᵢ is the vertical stack of K key-dependent random realizations of rᵢ^{T}. With K≥LN, Rᵢ is of the full column rank LN with probability one, and in this case the above equation (when given the key S) is linearly invertible with a complexity order equal to O((LN)³).

An even simpler method of attack is as follows. Since v_{i,k}=r_{i,k,i}^{T}x where l∈{1, . . . , L} and r_{i,k,l} for all i, k and l are known, then we can compute

$$\begin{matrix}{l}^{*} = arg {min}_{l ∈ \{ 1 , … , L \}} {min}_{x} {‖ {v}_{i} - {R}_{i , l} x ‖}^{2} \\ = arg {min}_{l ∈ \{ 1 , … , L \}} {‖ {v}_{i} - {R}_{i , l} {R}_{i , l}^{+} {v}_{i} ‖}^{2}\end{matrix} \qquad ( 9 )$$

where R_{i,l} is the vertical stack of r^{T}_{i,k,l} for k=1, . . . , K. Provided K≥N, WI has the full column rank with probability one. In this case, the correct solution of x is given by R⁺_{i.l}*vᵢ. This method has a complexity order equal to O(LN³).

2) Assuming “Function II” in [6]: To attack “Function II” with known S, it is equivalent to consider the following signal model:

$${v}_{k} = {\sum }_{n = 1}^{N} {r}_{k , {l}_{k} , n} {x}_{n} \qquad ( 10 )$$

where vₖ is available for k=1, . . . , K, r_{k,l,n} for 1≤k≤K, 1≤1≤L and 1≤n≤N are random but known¹ numbers (when given S), xₙ for all n are unknown, and lₖ is a kdependent random/unknown choice from [1, . . . , L]. ¹ “random but known” means “known” strictly speaking despite a pseudorandomness.

This can be expressed as:

v=Rx (11)

where v is a stack of all vₖ, x is a stack of all xₙ, and R is a stack of all r_{k,l}_{ₖ}_{,n} (i.e., (R)_{k,n}=r_{k,l}_{ₖ}_{,n}). In this case, R is a random and unknown choice from L^{K} possible known matrices. An exhaustive search would require the O(L^{K}) complexity with K≥N+1.

Now, consider a different approach of attack. Since r_{k,l,n} for all k,l,n are known, we can compute

$${c}_{n , {n}^{′}} = \frac{1}{KL} {\sum }_{k = 1}^{K} {\sum }_{l = 1}^{L} {\sum }_{{l}^{′} = 1}^{L} {r}_{k , l , n} {r}_{k , {l}^{′} , {n}^{′}} \qquad ( 12 )$$

If r_{k,l,n} are pseudo i.i.d. random (but known) numbers of zero mean and variance one, then for large K (e.g., K>>L²) we have c_{n,n′}≈δ_{n,n′}.

Also define

$${y}_{n} = \frac{1}{K} {\sum }_{k = 1}^{K} {\sum }_{l = 1}^{L} {v}_{k} {r}_{k , l , n} = {\sum }_{{n}^{′} = 1}^{N} {\hat{c}}_{n , {n}^{′}} {x}_{{n}^{′}} \qquad ( 13 )$$

where n=1, . . . , N and

$${\hat{c}}_{n , {n}^{′}} = \frac{1}{K} {\sum }_{k = 1}^{K} {\sum }_{l = 1}^{L} {r}_{k , l , n} {r}_{k , {l}_{k} , {n}^{′}} . \qquad ( 14 )$$

If r_{k,l,n} are i.i.d. of zero mean and unit variance, then for large K we have ĉ_{n,n′}≈c_{n,n′}≈δ_{n,n}0 and hence

yₙ≈xₙ (15)

More generally, if we have c\hat{ }_{n,n′}≈c_{n,n′} with a large K, then

y≈Cx (16)

where (y)ₙ=yₙ, and (C)_{n,n′}=c_{n,n′}. Hence,

x≈C⁻¹y. (17)

With an initial estimate \hat{x} of x, we can then do the following to refine the estimate:
(1) For each of k=1, . . . , K, compute lₖ*=arg min_{/∈[1, . . . , L]}|vₖ−Σ^{N}ₙ₌₁r_{k,l,n} \hat{x}ₙ|.
(2) Recall v=Rx. But now use (R)_{k,n}=r_{k,l*}_{ₖ}_{,n} for all k and n, and replace \hat{x} by

\hat{x}=(R^{T}R)⁻¹R^{T}v (18)

(3) Go to step 1 until convergence.

Note that all entries in R are discrete. Once the correct R is found, the exact x is obtained. The above algorithm converges to either the exact x or a wrong x. But with a sufficiently large K with respect to a given pair of N and L, our simulation shows that above attack algorithm yields the exact x with high probabilities. For example, for N=8, L=8 and K=23L, the successful rate is 99%. And for N=16, L=48 and K=70L, the successful rate is 98%. In the experiment, for each set of N, L and K, 100 independent realizations of all elements in x and R were chosen from i.i.d. Gaussian distribution with zero mean and unit variance. The successful rate was based on the 100 realizations.

In [6], an element-wise quantized version of v was further suggested to improve the hardness to invert. In this case, the vector potentially exposable to an attacker can be written as

\hat{v}=Rx+w (19)

where w can be modelled as a white noise vector uncorrelated with Rx. The above attack algorithm with v replaced by i also applies although a larger K is needed to achieve the same rate of successful attack.

In all of the above cases, the computational complexity for a successful attack is a polynomial function N, L and/or K when the secret key S is given.

C. Unitary Random Projection

None of the RP and DRP methods is homomorphic. To have a homomorphic CEF whose input and output have the same distance measure, we can use

yₖ=Rₖx (20)

where Rₖ∈R^{N×N} for each realization index k is a pseudorandom unitary matrix governed by a secret key S. Clearly, if y′ₖ=Rₖx′, then ∥y′ₖ−yₖ∥=∥x′ₖ−xₖ∥.

If Rₖ is just a permutation matrix, then the distribution of the elements of x is the same as that of yₖ for each k. To hide the distribution of the entries of x from yₖ for any k, we can let Rₖ=P_{k,2}QP_{k,1} where Q is a fixed unitary matrix (such as the discrete Fourier transform matrix), and P_{k,1} and P_{k,2} are pseudo-random permutation matrices governed by the seed S. This projection makes the distribution of the elements of yₖ differ from that of x. For large N, the distribution of the elements of yₖ approaches the Gaussian distribution for each typical x. Conditioned on a fixed key S, if the entries in x are i.i.d. Gaussian with zero mean and variance then the entries in each yᵢ are also i.i.d. Gaussian with zero mean and the variance σₓ². In this case, the entropy-preserving property holds.

To further scramble the distribution of yₖ, we can add one or more layers of pseudo-random permutation and unitary transform, e.g., Rₖ=P_{k,3}QP_{k,2}QP_{k,1}.

For unitary Rₖ, we also have ∥yₖ∥=∥x∥, which means that ∥x∥ is not protected from yₖ. If ∥x∥ needs to be protected, we can apply the transformation shown next.

1) Transformation from R^{N} to S^{N}(1): We now introduce a transformation from the N-dimensional vector space R^{N} to the N-dimensional sphere of unit radius S^{N}(1). Let x∈R^{N}.

Define

$$v = [ \begin{matrix}\frac{1}{‖ x ‖ \sqrt{1 + {‖ x ‖}^{2}}} x \\ \frac{‖ x ‖}{\sqrt{1 + {‖ x ‖}^{2}}}\end{matrix} ] \qquad ( 21 )$$

which clearly satisfies v∈S^{N}(1). Then, we let

yₖ=Rₖv (22)

where Rₖ is now a (n+1)×(n+1) unitary random matrix governed by a secret key S.

Let y′ₖ=Rₖ,v′. It follows that ∥y′ₖ−yₖ∥=∥v′−v∥. But since v is now a nonlinear function of x, the relationship between ∥v′−v∥ and ∥x′−x∥ is more complicated, which is discussed below.

Let us consider x′=x+w. One can verify that

$$\begin{matrix}‖ {v}^{′} - v ‖ = ‖ [ \begin{matrix}\frac{x + w}{‖ x + w ‖ \sqrt{1 + {‖ x + w ‖}^{2}}} \\ \frac{‖ x + w ‖}{\sqrt{1 + {‖ x + w ‖}^{2}}}\end{matrix} ] - [ \begin{matrix}\frac{x}{‖ x ‖ \sqrt{1 + {‖ x ‖}^{2}}} \\ \frac{‖ x ‖}{\sqrt{1 + {‖ x ‖}^{2}}}\end{matrix} ] ‖ \\ = ‖ [ \begin{matrix}\frac{a}{b} \\ \frac{c}{d}\end{matrix} ] ‖\end{matrix} \qquad ( 23 )$$

$$where$$

$$\begin{matrix}a = ( x + w ) \cdot ‖ x ‖ \cdot √ 1 + {‖ x ‖}^{2} \\ - x \cdot ‖ x + w ‖ \cdot \sqrt{1 + {‖ x + w ‖}^{2}}\end{matrix} \qquad ( 24 )$$

$$b = ‖ x ‖ \cdot \sqrt{1 + {‖ x ‖}^{2}} \cdot ‖ x + w ‖ \cdot \sqrt{1 + {‖ x + w ‖}^{2}} \qquad ( 25 )$$

$$c = ‖ x + w ‖ \cdot \sqrt{1 + {‖ x ‖}^{2}} - ‖ x ‖ \cdot \sqrt{1 + {‖ x + w ‖}^{2}} \qquad ( 26 )$$

$$d = \sqrt{1 + {‖ x ‖}^{2}} ‖ \cdot \sqrt{1 + {‖ x + w ‖}^{2}} . \qquad ( 27 )$$

To derive a simpler relationship between ∥v′−v∥ and ∥x′−x∥=∥w∥, assume ∥w∥<<r÷∥x∥ and apply the first order approximations. Also we can write

w=ηₓwₓ+η_{⊥}w_{⊥} (28)

where wₓ is a unit-norm vector in the direction of x, and w_{⊥} is a unit-norm vector orthogonal to x. Then,

∥w∥²=ηₓ²+η_{⊥}² (29)

x^{T}w=ηₓ∥x∥=ηₓr. (30)

It follows that

$$\begin{matrix}‖ x + w ‖ \approx ‖ x ‖ \\ + \frac{1}{2 ‖ x ‖} ( {‖ w ‖}^{2} + 2 {x}^{T} w ) \\ = r + \frac{1}{2 r} ( {η}_{x}^{2} + {η}_{⊥}^{2} + 2 r {η}_{x} ) \\ \approx r + \frac{1}{2 r} ( {η}_{⊥}^{2} + 2 r {η}_{x} )\end{matrix} \qquad ( 31 )$$

$$\begin{matrix}\sqrt{1 + {‖ x + w ‖}^{2}} \approx \sqrt{1 + {‖ x ‖}^{2}} \\ + \frac{1}{2 \sqrt{1 + {‖ x ‖}^{2}}} ( {‖ w ‖}^{2} + 2 {x}^{T} w ) \\ \approx \sqrt{1 + {r}^{2}} + \frac{1}{2 \sqrt{1 + {r}^{2}}} ( {η}_{⊥}^{2} + 2 r {η}_{x} )\end{matrix} . \qquad ( 32 )$$

Then, one can verify that

$$a \approx wr \sqrt{1 + {r}^{2}} - x \frac{1}{2} ( \frac{r}{\sqrt{1 + {r}^{2}}} + \frac{\sqrt{1 + {r}^{2}}}{r} ) ( {η}_{}^{2} + 2 r {η}_{x} ) \qquad ( 33 )$$

$$and$$

$$\begin{matrix}{‖ a ‖}^{2} = {r}^{2} ( 1 + {r}^{2} ) ( {η}_{x}^{2} + {η}_{⊥}^{2} ) \\ + \frac{1}{4} {{r}^{2} ( \frac{r}{\sqrt{1 + {r}^{2}}} + \frac{\sqrt{1 + {r}^{2}}}{r} )}^{2} {( {n}_{⊥}^{2} + 2 r {η}_{x} )}^{2} \\ - {η}_{x} {r}^{2} \sqrt{1 + {r}^{2}} ( \frac{r}{\sqrt{1 + {r}^{2}}} + \frac{\sqrt{1 + {r}^{2}}}{r} ) ( {η}_{⊥}^{2} + 2 r {η}_{x} ) \\ \approx {r}^{2} ( 1 + {r}^{2} ) ( {η}_{x}^{2} + {η}_{⊥}^{2} ) \\ + {{r}^{4} ( \frac{r}{\sqrt{1 + {r}^{2}}} + \frac{\sqrt{1 + {r}^{2}}}{r} )}^{2} {η}_{x}^{2} \\ - 2 {r}^{3} \sqrt{1 + {r}^{2}} ( \frac{r}{\sqrt{1 + {r}^{2}}} + \frac{\sqrt{1 + {r}^{2}}}{r} ) {η}_{x}^{2} \\ = {r}^{2} ( 1 + {r}^{2} ) {η}_{⊥}^{2} + \frac{{r}^{6}}{1 + {r}^{2}} {η}_{x}^{2}\end{matrix} \qquad ( 34 )$$

where the approximations hold because of ηₓ<<r and η_{⊥}<<r. Similarly, we have

$${b}^{2} \approx {{r}^{4} ( 1 + {r}^{2} )}^{2} \qquad ( 35 )$$

$${c}^{2} \approx {( \frac{1}{2 r \sqrt{1 + {r}^{2}}} ( {η}_{⊥}^{2} + 2 r {η}_{x} ) )}^{2} \approx \frac{1}{( 1 + {r}^{2} )} {η}_{x}^{2} \qquad ( 36 )$$

$${d}^{2} \approx {( 1 + {r}^{2} )}^{2} . \qquad ( 37 )$$

$$Hence$$

$${‖ {v}^{′} - v ‖}^{2} = \frac{{‖ a ‖}^{2}}{{b}^{2}} + \frac{{c}^{2}}{{d}^{2}} \approx \frac{1}{{r}^{2} ( 1 + {r}^{2} )} {η}_{⊥}^{2} + \frac{{r}^{2} + 1}{{( 1 + {r}^{2} )}^{3}} {η}_{x}^{2} . \qquad ( 38 )$$

It is somewhat expected that the larger is r, the less are the sensitivities of ∥v′−v∥² to η_{⊥} and ηₓ. But the sensitivities of ∥v′−v∥² to η_{⊥} and ηₓ are different in general, which also vary differently as r varies. If r<<1, then

$${‖ {v}^{′} + v ‖}^{2} \approx \frac{1}{{r}^{2}} {η}_{⊥}^{2} + {η}_{x}^{2} \qquad ( 39 )$$

which shows a higher sensitivity of ∥v′−v∥² to η_{⊥} than to ηₓ, If r>>1, then

$${‖ {v}^{′} + v ‖}^{2} \approx \frac{1}{{r}^{4}} {η}_{⊥}^{2} + \frac{1}{{r}^{4}} {η}_{x}^{2} = \frac{1}{{r}^{4}} {‖ w ‖}^{2} \qquad ( 40 )$$

which shows equal sensitivities of ∥v′−v∥² to η_{⊥} and ηₓ respectively.

The above results show how ∥v′−v∥² changes with w=η_{⊥}w_{⊥}+ηₓwₓ subject to ∥w∥<<∥x∥=r or equivalently \sqrt{η_{⊥}²+ηₓ²}<<r.

For larger ∥w∥, the relationship between ∥v′—v∥² and ∥w∥ is not as simple. But one can verify that if ∥w∥>>r>>1, then ∥v′−v∥≈1/r.

D. Secret Key Generation From x

The secret key S needed for the linear family of CEFs can be generated from a private device or directly from x. In the latter case, a reliable generation of S based on two observations of x requires a statistical knowledge of the observations. We now let x and x′ (instead of x_{A} and x_{B}) be two realizations of a common feature vector, then an identical key S should be generated from either x or x′ with a sufficiently high probability.

If x and x′ represent two observations of a memoryless random feature and the two observations are made at two different locations (A and B), then the key generation at location A can take into account feedbacks via a public channel from the key generation at location B, and via versa. With the feedbacks, the capacity (the number of secret bits per independent realization of x and x′) of a common secret key generated from x and x′ is given by the mutual information I(x;x′) assuming that eavesdropper's knowledge of x and x′ is zero [11]-[12].

But if x is a current realization and x′ is a future realization, then no feedback is possible from any action on x′ to any action on x. Furthermore, if the underline feature vector for x and x′ is not a memoryless random process (such as a constant process like a typical biometric feature), then the theory in [11]-[12] does not apply. In this case, only an “open loop” scheme is possible, which is illustrated below.

Assume x′=x+w where w is [symbol] (0, μ_{w}²Iₙ). Let xᵢ and x′ᵢ be the ith elements of x and x′ respectively. Let Q be a uniform quantizer with the quantization interval equal to Δ. Let Q₀, . . . , Q_{L-1} be a set of L companion quantizers of Q, which are uniformly interleaved with each other. To quantize each xᵢ, we use Q. From xᵢ, the best companion quantizer Qₗ. is chosen from Q₀, . . . , Q_{L-1}, i.e., one of the middle points of the quantization intervals in among all companion quantizers is the closest to xᵢ. Then Qₗ. is used to quantize x′ᵢ.

If L>>i, the probability for xᵢ and x′ᵢ to be quantized differently is

$${p}_{e} \leq Q ( \frac{Δ}{2 {σ}_{u}} ) . If {p}_{c} << 1 ,$$

the overall probability of quantization error (x and x′ producing different keys) is

Pₑ=1−(1−pₑ)^{N}≈Npₑ (41)

By controlling Δ, we can make Pₑ as small as needed.

The entropy H(S) of the key generated from x can be determined as follows. Assume that L>>1 and all N entries in x are i.i.d., and each entry has a symmetric PDF (probability density function) ƒ(x). Corresponding to the quantizer Q, there is a set of probabilities . . . , p₋₁, p₀, p₁, . . . where pₘ=∫_{-Δ/2+mΔ}^{Δ/2+mΔ}∫(x)dx. Then,

$$H ( S ) = N {\sum }_{m = - ∞}^{∞} {p}_{m} {log}_{2} \frac{1}{{p}_{m}} . \qquad ( 42 )$$

There is a tradeoff between H(S) and Pₑ. As Δ increases from zero to infinity, Pₑ decreases to zero, but H(S) also decreases to zero. In practice, Δ should be chosen such that Pₑ is sufficiently small while H(S) is still significant. If all entries of x are i.i.d., then each entry should be quantized into at least two levels.

Consider a binary quantizer Q that quantizes each xᵢ into either positive or negative. Here Q consists of the intervals [−Δ, 0), [0, Δ]. The lth companion quantizer Qₗ consists of the intervals [−Δ+1/LΔ, 1/LΔ), [1/L Δ, Δ+1/LΔ] where l=0, 1, . . . , L−1. A large enough A needs to be chosen, so that xᵢ belongs to either [−Δ, 0) or [0, Δ], and xᵢ is quantized by Q into either positive or negative. Also the best quantizer Qₗ; with respect to xᵢ is kept as a public information and will be used to quantize x′ᵢ into either “positive” or “negative”. Here

$${l}_{i}^{*} = arg {min}_{l} min ( {x}_{i} + \frac{1}{2} Δ - \frac{l}{L} Δ , {x}_{i} - 1 \frac{}{2} Δ - \frac{l}{L} Δ ) . \qquad ( 43 )$$

Note that while a binary quantizer seems feasible to produce a secret key in most applications, for such a coarse quantization many biometric feature vectors from different users could lead to the same key. In practice, it should be the best to combine an external key Sₑ (if any) with the key Sₓ generated from x into a composite key S=Sₑ×Sₓ, which is then used in a CEF.

It is important to stress here that if the available statistical models of x and x′ are too conservative, then the entropy of the key Sₓ extracted from x and x′ would be far less than its potential. In this case, if the composite key S is not sufficiently large, then there is a strong need for CEF that is still hard to invert even if S is exposed.

### III. NONLINEAR FAMILY OF CEF

If the composite secret key S is still not large enough, then consider CEF based on nonlinear functions since they are often hard to invert even if S is known.

A. Higher-Order Polynomials

A family of higher-order polynomials (HOP) was suggested in [7] as a hard-to-invert continuous function. But it is shown below that HOP does not have the hard-to-substitute property.

Let y=[y₁, . . . , y_{M}]^{T} and x=[x₁, . . . , X_{N}]^{T} where yₘ is a HOP of x₁, . . . , x_{N} with pseudo-random coefficients. Namely, yₘ=ƒₘ(x₁, . . . , x_{N})=Σᵢ₌₀¹c_{m,i}x₁^{p}^{_{1,i}}, . . . x_{N}^{p}^{_{N,i}} where the coefficients c_{m,i} are pseudo-random numbers governed by S. When S is known, all the polynomials are known and yet x is still generally hard to obtain from y for any M due to the nonlinearity. But we can write yₘ=gₘ(v(x₁, . . . , x_{N})), where gₘ is a scalar linear function conditioned on S, and v(xᵢ, . . . , x_{N}) is a vector nonlinear function unconditioned on S. This means that the HOP is not a hard-to-substitute function.

B. Index-of-Max Hashing

More recently a method called index-of-max (IoM) hashing was proposed in [8] and applied in [10]. There are algorithms 1 and 2 based on IoM, which will be referred to as IoM-1 and IoM-2.

In IoM-1, the feature vector x∈R^{N} is multiplied (from the left) by a sequence of L×N pseudo-random matrices R₁, . . . , R_{K}_{₁} to produce v₁, . . . , v_{K}_{₁}, respectively. The index of the largest element in each vₖ is used as an output yₖ. With y=[y₁, . . . , y_{K}_{₁}]^{T}, y is a nonlinear (“piece-wise” constant and “piece-wise” continuous) continuous function of x.

In IoM-2, R₁, . . . , R_{K}_{₁} used in IoM-1 are replaced by N×N pseudo-random permutation matrices P₁, . . . , P_{K}_{₁} to produce v₁, . . . , v_{K}_{₁}, and then a sequence of vectors w₁, . . . , w_{K}_{₂} are produced in such a way that each wₖ is the element-wise products of an exclusive set of p vectors from v₁, . . . , v_{K}_{₁}. The index of the largest element in each wₖ is used as an output yₖ. With y=[y₁, . . . , y_{K}_{₂}]^{T}, y is another nonlinear continuous function of x.

Next is shown that IoM-1 is not hard to invert if the secret key S or equivalently the random matrices R₁, . . . , R_{K}_{₁}, are known. IoM-2 is also not hard to invert up to the sign of each element in x if the secret key S or equivalently the random permutations R₁, . . . , R_{K}_{₁}, are known.

1) Attack of IoM-1: Assume that each Rₖ has L rows and the secret key S is known. Then knowing yₖ for k=1, . . . , K₁ means knowing r_{k,a,l} and r_{k,b,l} satisfying

r^{T}_{k,a,l}x>r^{T}_{kb,l}x (44)

with l=1, . . . , L−1 and k=1, Here r^{T}_{k,a,l} and r^{T}_{k,b,l} for all 1 are rows of Rₖ. The above is equivalent to d^{T}_{k,l} x>0 with d_{k,l}=r_{k,b,l}, or more simply

d^{T}ₖx>0 (45)

where dₖ is known for k=1, . . . , K with K=K₁(L−1).

Note that any scalar change to x does not affect the output y. Also note that even though IoM-1 defines a nonlinear function from x to y, the conditions in (45) useful for attack are linear with respect to x.

TABLE I
NORMALIZED PROJECTION OF x ONTO ITS ESTIMATE
USING ONLY AVERAGING FOR ATTACK OF IOM-1

| | K₁ = 8 | 16 | 32 | 64 |
|---|---|---|---|---|
| N = 8 | 0.8546 | 0.9171 | 0.9562 | 0.9772 |
| 16 | 0.8022 | 0.8842 | 0.9365 | 0.9666 |
| 32 | 0.7328 | 0.8351 | 0.906 | 0.9494 |

TABLE II
NORMALIZED PROJECTION OF x ONTO
ITS ESTIMATE AFTER CONVERGENCE
OF REFINEMENT FOR ATTACK OF IOM-1

| | K₁ = 8 | 16 | 32 | 64 |
|---|---|---|---|---|
| N = 8 | 0.8807 | 0.9467 | 0.9804 | 0.9937 |
| 16 | 0.8174 | 0.908 | 0.9612 | 0.9861 |
| 32 | 0.739 | 0.8497 | 0.9268 | 0.9699 |

To attack IoM-1, compute x satisfying d^{T}ₖ\hat{x}>0 for all k. One such algorithm of attack is as follows:
1) Initialization/averaging: Let

$$\hat{x} = \overline{d} \dot{=} \frac{1}{K} {\sum }_{k = 1}^{K} {d}_{k} .$$

2) Refinement: Until d^{T}ₖ\hat{x}>0 for all k, choose k*=arg minₖ d^{T}ₖ\hat{x}, and compute

\hat{x}< . . . \hat{x} . . . η(dₖ^{T},\hat{x})dₖv (46)

where η is a step size.

Our simulation

$$( using η = \frac{1}{{‖ {d}_{{k}^{*}} ‖}^{2}} )$$

shows that using the initialization alone can yield a good estimate of x as K increases. More specifically, the normalized projection

$$\frac{{\overline{d}}^{T} x}{‖ \overline{d} ‖ \cdot ‖ x ‖}$$

converges to one as K increases. Our simulation also shows that the second step in the above algorithm improves the convergence slightly. Examples of the attack results are shown in Tables I and II where L=N. IoM-1 (with its key S exposed) can be inverted with a complexity order no larger than a linear function of N and K₁ respectively.

2) Attack of IoM-2: To attack IoM-2, we need to know the sign of each element of x, which is assumed below. Given the output of IoM-2 and all the permutation matrices P₁, . . . , P_{K}_{₁}, we know which of the elements in each wₖ is the largest and which of these elements are negative. If the largest element in wₖ is positive, we will ignore all the negative elements in wₖ. If the largest element in wₖ is negative, we know which of the elements in wₖ has the smallest absolute value.

Let |wₖ| be the vector consisting of the corresponding absolute values of the elements in wₖ. Also let log |wₖ| be the vector of element-wise logarithm of |wₖ|. It follows that

log |wₖ|=Tₖ log |x| (47)

where Tₖ is the sum of the permutation matrices used for wₖ. The knowledge of an output yₖ of IoM-2 implies the knowledge of t^{T}_{k,a,l} and t^{T}_{k,b,l} (i.e., row vectors of Tₖ) such that either

t_{k,a,l}^{T} log |x|>t_{k,b,l} log |x| (48)

with l=1, . . . , Lₖ−1 if wₖ has Lₖ≥2 positive elements, or

t_{k,a,l}^{T} log |x|<t_{k,b,l} log |x| (49)

with l=1, . . . , N−1 if wₖ has no positive element.

TABLE III
NORMALIZED PROJECTION OF |x| ONTO ITS ESTIMATE
USING ONLY AVERAGING FOR ATTACK OF IOM-2

| | K₂ = 8 | 16 | 32 | 64 |
|---|---|---|---|---|
| N = 8 | 0.9244 | 0.954 | 0.9698 | 0.9783 |
| 16 | 0.9068 | 0.9418 | 0.9603 | 0.9694 |
| 32 | 0.8844 | 0.9206 | 0.9379 | 0.9466 |

TABLE IV
NORMALIZED PROJECTION OF |x| ONTO
ITS ESTIMATE AFTER CONVERGENCE OF REFINEMENT
FOR ATTACK OF IOM-2

| | K₂ = 8 | 16 | 32 | 64 |
|---|---|---|---|---|
| N = 8 | 0.9432 | 0.9711 | 0.9802 | 0.9816 |
| 16 | 0.9182 | 0.9525 | 0.9649 | 0.9653 |
| 32 | 0.8887 | 0.9258 | 0.9403 | 0.9432 |

If wₖ has only one positive element, the corresponding yₖ is ignored as it yields no useful constraint on log |x|. Assume that no element in x is zero.

Equivalently, the knowledge of yₖ implies c^{T}_{k,l} log |x|>0 where cₖ₁=t_{k,a1}−t_{k,b1} for l=1, . . . , Lₖ−1 if wₖ has Lₖ≥2 positive elements, or c_{k,l}=−t_{k,a,l}+t_{k,b,l} for l=1, . . . , N−1 if wₖ has no positive element. A simpler form of the constraints on log |x| is

c^{T}ₖ log |x|>0 (50)

where cₖ is known for k=1, . . . , K with K=Σₖ₌₁^{K}^{₂}(\dot{L}ₖ−1). Here L̅ₖ=Lₖ if wₖ has a positive element, and L̅ₖ=N if wₖ has no positive element.

The algorithm to find log |x| satisfying (50) for all k is similar to that for (45), which consists of “initialization/averaging” and “refinement”. Knowing log |x|, we also know lxi. Examples of the attack results are shown in Tables III and IV where p=N and all entries of x are assumed to be positive.

The above analysis shows that IoM-2 effectively extracts out a binary (sign) secret from each element of x and utilizes that secret to construct its output. Other than that secret, IoM-2 is not a hard-to-invert function. In other words, IoM-2 can be inverted with a complexity order no larger than P_{N,K}_{₂}2^{N} where P_{N,K}_{₂} is a linear function of N and K₂, respectively, and 2^{N} is to due to an exhaustive search of the sign of each element in x. Note that if an additional key Sₓ of N bits is first extracted from the signs of the elements in x, then a linear CEF can be used while maintaining an attack complexity order equal to O(N³2^{N}).

### IV. A NEW FAMILY OF NONLINEAR CEF

The previous discussions show that RP, DRP and IoM-1 are not hard to invert, and IoM-2 can be inverted with a complexity order no larger than P_{N,K}_{₂}2^{N}. Below shows a new family of nonlinear CEF, for which the best known method to attack suffers a complexity order no less than O(2^{ζN}) with ζ much larger than one.

The new family of nonlinear CEFs is broadly defined as follows. Step 1: let M_{k,x} be a matrix (for index k) consisting of elements that result from a random modulation of the input vector x∈R^{N}. Step 2: Each element of the output vector y∈R^{M} is constructed from a component of the singular value decomposition (SVD) of M_{k,x} for some k. Each of the two steps can have many possibilities. Next, focus on one specific CEF in this family.

For each pair of k and l, let Q_{k,l} be a (secret key dependent) random N×N unitary (real) matrix. Define

M_{k,x}=[Q_{k,x}, . . . ,Q_{k,N}x] (51)

where each column of M_{k,x} is a random rotation of x. Let u_{k,x,1} be the principal left singular vector of M_{k,x}, i.e.,

$${u}_{k , x , 1} = arg {max}_{u , ‖ u ‖ = 1} {u}^{T} {M}_{k , x} {M}_{k , x}^{T} u \qquad ( 52 )$$

Then for each k, choose N_{y}<N elements in u_{k,x,1} to be N_{y} elements in y. For convenience, the above function (from x to y) is referred to as SVD-CEF. Note that there are various ways to perform the forward computation needed for (52). One of them is the power method [15], which has the complexity equal to O(N²).

For each random realization of Q_{k,l} for all k and l and a random realization x₀ of x, with probability one, there is a neighborhood around x₀ within which y is a continuous function of x. For any fixed x the elements in y appear random to anyone who does not have access to the secret key used to produce the pseudorandom Q_{k,l}. In the next two sections below, provided are discussions in relation to the five properties of CEF.

### V. SVD-CEF IS HARD TO INVERT AND HARD TO SUBSTITUTE

The following considers how to compute x∈R^{N} from a given y∈R^{M} with M≥N for the SVD-CEF based on (51) and (52) assuming that Q_{k,l} for all k and l are also given.

One method (a universal method) is via exhaustive search in the space of x until a desired x is found (which produces the known y via the forward function). This method has a complexity order (with respect to N) no less than O(2^{N}^{_{B}}^{N}) with Na being the number of bits needed to represent each element in x. The value of Na depends on noise level in x. It is not uncommon in practice that N_{B} ranges from 3 to 8 or even larger.

Another method to invert a nonlinear function is the Newton's method, which is considered next. To prepare for the application of the Newton's method, a set of equations needs to be formulated that must be satisfied by all unknown variables.

A. Preparation

Assume that for each of k=1, . . . , K, N_{y} elements of u_{k,x,1} are used to construct y∈R^{M} with M=KN_{y}. To find x from known y and known Q_{k,l} for all k and l, we can solve the following eigenvalue-decomposition (EVD) equations:

M_{k,x}M^{T}_{k,x}U_{k,x,1}=σ_{k,x},²₁u_{k,x,1} (53)

with k=1, . . . , K. Here ρ²_{k,x,l} is the principal eigenvalue of M_{k,x}M^{T}_{k,x}. But this is not a conventional EVD problem because the vector x inside M_{k,x} is unknown along with σ²_{k,x,l} and N−N_{y} elements in u_{k,x,1} for each k. Refer to (53) as the EVD equilibrium conditions for x.

If the unknown x is multiplied by α, so should be the corresponding unknowns σ_{k,x,1} for all k but u_{k,x,1} for any k is not affected. So, consider the solution satisfying ∥x∥²=1. Note that if the norm of the original feature vector contains secret, we can first use the transformation shown in section II-C1 above.

The number of unknowns in the system of nonlinear equations (53) is N_{unk,EV D,1}=N+(N−N_{y})K+K, which consists of all N elements of x, N−N_{y} elements of u_{k,x,1} for each k and σ²_{k,x,l} for all k. The number of the nonlinear equations is N_{equ,Ev D,1}=NK+K+1, which consists of (53) for all k, ∥u_{k,x,1}∥=1 for all k and ∥x∥²=1. Then, the necessary condition for a finite set of solutions is N_{equ,EV D,1}≥N_{unk,EV D,1}, or equivalently N_{y}K≥N−1.

If N_{y}<N, there are N−N_{y} unknowns in u_{k,x,1} for each k and hence the left side of (53) is a third-order function of unknowns. To reduce the nonlinearity, the space of unknowns can be expanded as follows. Since M_{k,x} M^{T}_{k,x}=Σₗ₌₁^{N}Q_{k,l}XQ_{k,l}^{T} with X=xx^{T}, we can treat X as a N×N symmetric unknown matrix (without the rank-1 constraint), and rewrite (53) as

$$( {\sum }_{l = 1}^{N} {Q}_{k , l} {XQ}_{k , l}^{T} ) {u}_{k , x , 1} = {σ}_{k , x , 1}^{2} {u}_{k , x , 1} \qquad ( 54 )$$

with Tr(X)=1, ∥u_{k,x,l}∥=1 and k=1, . . . , K. In this case, both sides of (54) are of the 2nd order of all unknowns. But the number of unknowns is now N_{unk,EV D,2}=½N(N+1)+(N−N_{y}K+K>N_{unk,EV D,1} while the number of equations is not changed, i.e., N_{equ,EV D,2}=N_{equ,EV D,1}=NK+K+1. In this case, the necessary condition for a finite set of solution for X is N_{equ,EV D,2}≥N_{unk,EV D,2}, or equivalently

$${N}_{y} K \geq \frac{1}{2} N ( N + 1 ) - 1.$$

While X is a useful substitute for x, it is still hard to compute from y as shown later.

Alternatively, x satisfies the following SVD equations:

M_{k,x}V_{k,x}=U_{k,x}Σ_{k,x} (55)

with U^{T}_{k,x}U_{k,x}=I_{N} and V^{T}_{k,x}V_{k,x}=I_{N}. Here U_{k,x} is the matrix of all left singular vectors, V_{k,x} is the matrix of all right singular vectors, and Σ_{k,x} is the diagonal matrix of all singular values. The above equations are referred to as the SVD equilibrium conditions on x.

With N_{y} elements of the first column of U_{k,x} for each k to be known, the unknowns are the vector x, N²−N_{y} elements in U_{k,x} for each k, all N² elements in V_{k,x} for each k, and all diagonal elements in Σ_{k,x} for each k. Then, the number of unknowns is now N_{unk,SV D}=N+(N²−N_{y})K+N²K+NK, and the number of equations is N_{equ,sv D}=N²K+N(N+1)K+1. In this case, N_{equ,SV D}≥N_{unk,SV D} iff N_{y}K≥N−1. This is the same condition as that for EVD equilibrium. But the SVD equilibrium equations in (55) are all of the second order.

Note that for the EVD equilibrium, there is no coupling between different eigen-components. But for the SVD equilibrium, there are couplings among all singular-components. Hence the latter involves a much larger number of unknowns than the former. Specifically, N_{unk,SV D}>N_{unk,EV D,2}>N_{unk,EV D,1}.

Every set of equations that x must fully satisfy (given y) is a set of nonlinear equations, regardless of how the parameterization is chosen. This is the fundamental reason why the SVD-CEF is hard to invert. SVD is a three-factor decomposition of a real-valued matrix, for which there are efficient ways for forward computations but no easy way for backward computation. If a two-factor decomposition of a real-valued matrix (such as QR decomposition) is used, the hard-to-invert property does not seem achievable.

In Appendix A, the details of an attack algorithm based on Newton's method are given.

B. Performance of Attack Algorithm

Since the conditions useful for attack of the SVD-CEF are always nonlinear, any attack algorithm with a random initialization x′ can converge to the true vector x (or its equivalent which produces the same y) only if x′ is close enough to x. To translate the local convergence into a computational complexity needed to successfully obtain x from y, now consider the following.

Let x be an N-dimensional unit-norm vector of interest. Any unit-norm initialization of x can be written as

x′=±\sqrt{1−r²}x+rw (56)

where 0<r≤1 and w is a unit-norm vector orthogonal to x. For any x, rw is a vector (or “point”) on the sphere of dimension N−2 and radius r, denoted by S^{N-2}(r). The total area of S^{N-2}(r) is known to be

$$\vert {𝒮}^{N - 2} ( r ) \vert = \frac{2 {π}^{\frac{- 1}{2}}}{Γ ( \frac{N - 1}{2} )} {e}^{N - 2} .$$

Then the probability for a uniformly random x′ from S^{N-1}(1) to fall onto S^{N-2}_{N}(r₀) orthogonal to \sqrt{1−r₀²}x with r≤r₀≤r+dr is

$$2 \frac{\vert {𝒮}^{N - 2} ( r ) \vert}{\vert {𝒮}^{N - 1} ( 1 ) \vert} dr$$

where the factor 2 accounts for ± in (56).

Therefore, the probability of convergence from x′ to x is

$$\begin{matrix}{P}_{conv} = {ε}_{x} \{ {\int }_{0}^{1} 2 {P}_{x , r} \frac{\vert {𝒮}^{N - 2} ( r ) \vert}{\vert {𝒮}^{N - 1} ( 1 ) \vert} dr \} \\ = \frac{2 Γ ( \frac{N}{2} )}{\sqrt{π} Γ ( \frac{N - 1}{2} )} {\int }_{0}^{1} {P}_{r} {r}^{N - 2} dr\end{matrix} \qquad ( 57 )$$

where Eₓ is the expectation over x, P_{x,r} is the probability of convergence from x′ to x when x′ is chosen randomly from S^{N-2}(r) orthogonal to a given √(1−r²)x, and Eₓ{P_{x,r}}=Pᵣ.

Pᵣ is the probability that the algorithm converges from x′ to x (including its equivalent) subject to a fixed r, uniformly random unit-norm x, and uniformly random unit-norm w satisfying w^{T}x=0. And Pᵣ can be estimated via simulation.

TABLE V
P_{r, N} AND ^{P}_{r, N}* IN % VERSUS r AND N

| | r | | | | | | | |
|---|---|---|---|---|---|---|---|---|
| | 0.001 | 0.01 | 0.1 | 0.3 | 0.5 | 0.7 | 0.9 | 1 |
| Pr, 4 | 46 | 24 | 6 | 0 | 1 | 1 | 1 | 0 |
| Pr, *4 | 45 | 17 | 4 | 0 | 1 | 0 | 1 | 0 |
| Pr, 8 | 29 | 7 | 1 | 0 | 0 | 0 | 0 | 0 |
| P_{r, 8}* | 25 | 5 | 0 | 0 | 0 | 0 | 0 | 0 |

If Pᵣ=0 for r≥rₘₐₓ (with rₘₐₓ<1), then

$${P}_{conv} = \frac{2 Γ ( \frac{N}{2} )}{\sqrt{π} Γ ( \frac{N - 1}{2} )} {\int }_{0}^{{r}_{max}} {P}_{r} {r}^{N - 2} dr < \frac{2 Γ ( \frac{N}{2} )}{( N - 1 ) \sqrt{π} Γ ( \frac{N - 1}{2} )} {r}_{max}^{N - 1} < {r}_{max}^{N - 1} \qquad ( 58 )$$

which converges to zero exponentially as N increases. In other words, for such an algorithm to find x or its equivalent from random initializations has a complexity order equal to

$$( \frac{1}{{P}_{conv}} ) > ( {( \frac{1}{{T}_{max}} )}^{N - 1} )$$

which increases exponentially as N increases.

In our simulation, rₘₐₓ was found to decrease rapidly as N increases. Let P_{r,N} be Pᵣ as function of N. Also let P*_{r,N} be the probability of convergence to \hat{x} which via the SVD-CEF not only yields the correct yₖ for k=1, . . . , K but also the correct yₖ for k>K (up to maximum absolute element-wise error no larger than 0.02). Here K is the number of output elements used to compute the input vector x. In the simulation, we chose N_{y}=1 and N_{equ,EV D,2}=N_{unk,EV D,2}+1, which is equivalent to K=½N(N+1). Shown in Table V are the percentage values of P_{r,N} versus r and N, which are based on 100 random choices of x. For each choice of x and each value of r, we used one random initialization of x′. (For N=8 and the values of r in this table, it took two days on a PC with CPU 3.4 GHz Dual Core to complete the 100 runs.)

### VI. STATISTICS OF SVD-CEF

The statistics of the output y of the SVD-CEF is directly governed by the statistics of the principal eigenvector uₖ=u_{k,x,l} of the matrix M_{k,x}M^{T}_{k,x}. So, much of the discussions shown next is focused on uₖ.

A. Input-Output Distance Relationships

Below is a discussion regarding the next the relationships between ∥Δx∥ and ∥Δy∥. Unlike the random unitary projections, here the relationship between ∥Δx∥ and ∥Δy∥ is much more complicated.

1) Local Sensitivities: First consider the case where ∥Δx∥<<1. It is clearly important to know how sensitive ∥Δy∥ is to ∥Δx∥ even just locally. Since all elements in y∈R^{M} are chosen from partial elements in u_{k,x,1}, we can focus on the sensitivity of u_{k,x,1} to perturbations in x, i.e., ∂u_{k,x,1} versus ∂ₓ.

Since u_{k,x,1} is the principal eigenvector of M_{k,x,1}M^{T}_{k,x}=Q_{k,l}xx^{T}Q_{k,l}^{T}, it is known [17] that

$$\partial {u}_{k , x , 1} = {\sum }_{j = 2}^{N} \frac{1}{{λ}_{1} - {λ}_{j}} {u}_{k , x , j} {u}_{k , x , j}^{T} \partial ( {M}_{k , x} {M}_{k , x}^{T} ) {u}_{k , x , 1} . \qquad ( 59 )$$

where λⱼ is the jth eigenvalue of M_{k,x} corresponding to the jth eigenvector u_{k,x,j}. Here ∂(M_{k,x}M^{T}_{k,x})=Σₗ Q_{k,l}∂xx^{T}Q^{T}_{k,l}+Σₗ Q_{k,l}x∂x^{T}Q^{T}_{k,l}. It follows that

∂u_{k,x,1}=T∂x (60)

where T=A+B with

$$A = {\sum }_{j = 2}^{N} \frac{1}{{λ}_{1} - {λ}_{j}} {u}_{k , x , j} {u}_{k , x , j}^{T} {\sum }_{l = 1}^{N} {Q}_{k , l} {x}^{T} {Q}_{k , l}^{T} {u}_{k , x , 1} \qquad ( 61 )$$

$$B = {\sum }_{j = 2}^{N} \frac{1}{{λ}_{1} - {λ}_{j}} {u}_{k , x , j} {u}_{k , x , j}^{T} {\sum }_{l = 1}^{N} {Q}_{k , l} {xu}_{k , x , 1}^{T} {Q}_{k , l} . \qquad ( 62 )$$

We can also write

$$\begin{matrix}T = ( {\sum }_{j = 2}^{N} \frac{1}{{λ}_{1} - {λ}_{j}} {u}_{k , x , j} {u}_{k , x , j}^{T} ) \\ \cdot ( {\sum }_{i = 1}^{N} {Q}_{k , l} [ ( {x}^{T} {Q}_{k , l}^{T} {u}_{k , x , 1} ) {I}_{N} + {xu}_{k , x , 1}^{T} {Q}_{k , l} ] )\end{matrix} \qquad ( 63 )$$

where the first matrix component has the rank N−1 and hence so does T.

Let ∂x=w which consists of i.i.d. elements with zero mean and variance σ_{w}²<<1. It then follows that

$${ℰ}_{w} \{ {‖ \partial {u}_{k , x , 1} ‖}^{2} \} = Tr \{ T {σ}_{w}^{2} {T}^{T} \} = {σ}_{w}^{2} {\sum }_{j = 1}^{N - 1} {σ}_{j}^{2} \qquad ( 64 )$$

where σⱼ for j=1, . . . , N−1 are the nonzero singular values of T. Since ε_{w}{∥∂x∥²}=Nσ_{w}², we have

$${η}_{k , x} \dot{=} \sqrt{\frac{{ℰ}_{w} \{ {‖ \partial {u}_{k , x , 1} ‖}^{2} \}}{{ℰ}_{w} \{ {‖ \partial x ‖}^{2} \}}} = \sqrt{\frac{1}{N} {\sum }_{j = 1}^{N - 1} {σ}_{j}^{2}} \qquad ( 65 )$$

which measures a local sensitivity of uₖ to a perturbation in x.

For each given x, there is a small percentage of realizations of {Q_{k,l}, l=1, . . . , N} that make η_{k,x} relatively large. To reduce η_{k,x}, we can prune away such bad realizations.

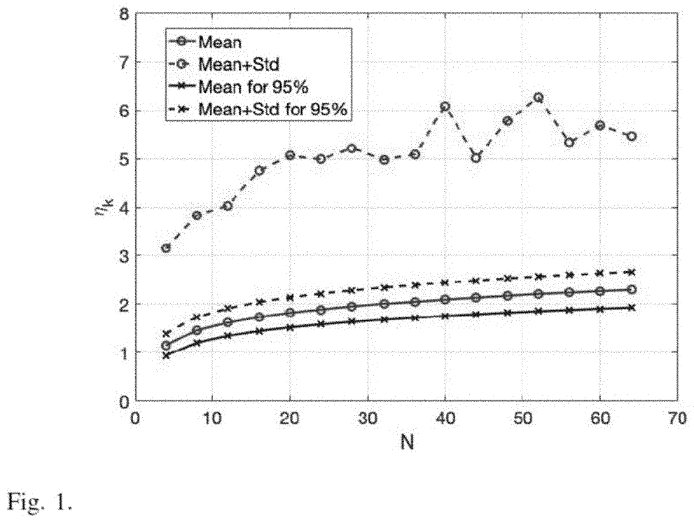

Shown in FIG. 1 are the means and means-plus-deviations of η_{k,x} (over choices of k and x) versus N, with and without pruning respectively. Here “std” stands for standard deviation. 5% pruning (or equivalently 95% inclusion shown in the figure) results in a substantial reduction of η_{k,x}. We used 1000×1000 realizations of x and {Q_{k,l}, l=1, . . . , N}.

Shown in Table VI are some statistics of η_{k,x} subject to η_{k,x}<2.5. And P_{good} is the probability of η_{k,x}<2.5.

TABLE VI
STATISTICS OF η_{k,x} SUBJECT TO η_{k,x} < 2.5 AND P_{good}

| N | 16 | 32 | 64 |
|---|---|---|---|
| Mean | 1.325 | 1.489 | 1.645 |
| Std | 0.414 | 0.397 | 0.371 |
| Pgood | 0.88 | 0.84 | 0.78 |

Global relationships: Any unit-norm vector x′ can be written as x′=±\sqrt{1−α}x+\sqrt{α}w where 0≤α≤1, and w is of the unit norm and satisfies w^{T}x=0. Then

$$‖ Δ x ‖ \leq ‖ {x}^{′} - x ‖ = \sqrt{2 - 2 \sqrt{1 - α}} .$$

It follows that ∥Δx∥≤\sqrt{2} and ∥Δuₖ∥\sqrt{2}. For given α in x′=±\sqrt{1−α}x+\sqrt{α}w, ∥Δx∥ is given while ∥Δuₖ∥ still depends on w.

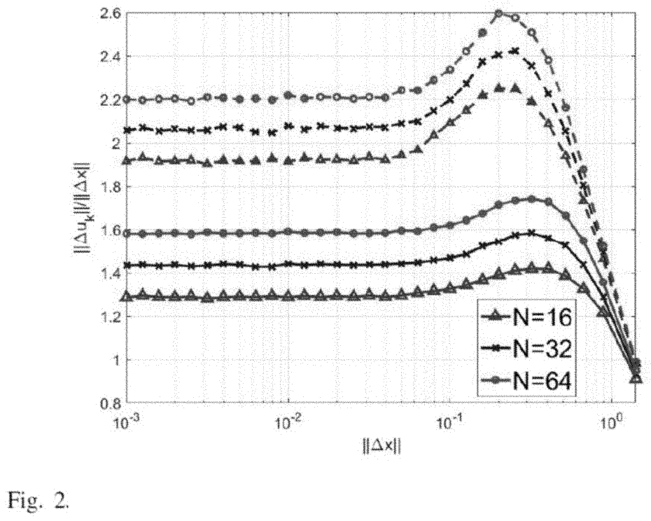

Shown in FIG. 2 are the means and means-plus-deviations of

$$\frac{‖ Δ {u}_{k} ‖}{‖ Δ x ‖}$$

versus ∥Δx∥ subject to η_{k,x}<2.5. This figure is based on 1000×1000 realizations of x and {Q_{k,1}, 1=1, . . . , N} under the constraint η_{k,x}<2.5.

B. Correlation Between Input and Output

1) When there is a secret key: Recall M_{k,x}=[Q_{k,1}x, . . . , Q_{k,N}x]. With a secret key, assume that Q_{k,1} for all k and l are uniformly random unitary matrices (from adversary's perspective). Then uₖ for all k and any x are uniformly random on S^{N-1}(1). It follows that ε_{Q} {uₖuₘ^{T}}=0 for k≠m, and E_{Q}{uₖx^{T}}=0. Furthermore, it can be show that

$${E}_{Q} \{ {u}_{k} {u}_{k}^{T} \} = \frac{1}{N} {I}_{N} ,$$

i.e., the entries of uₖ are uncorrelated with each other. Here E_{Q} denotes the expectation over the distributions of Q_{k,l}.

2) When there is no secret key: In this case, Q_{k,l} for all k and l must be treated as known. But consider typical (random but known) realizations of Q_{k,l} for all k and l.

To understand the correlation between x∈S^{N-1}(1) and uₖ∈S^{N-1}(1) subject to a fixed (but typical) set of Q_{k,l}, consider the following measure:

$${ρ}_{k} = N {max}_{i , j} \vert {[ {ℰ}_{x} \{ {xu}_{k}^{T} \} ]}_{i , j} \vert \qquad ( 66 )$$

where Eₓ denotes the expectation over the distribution of x. If uₖ=x, then ρₖ=1. So, if the correlation between x and uₖ is small, so should be ρₖ. For comparison, we define ρ*ₖ as ρₖ with uₖ replaced by a random unit-norm vector (independent of x).

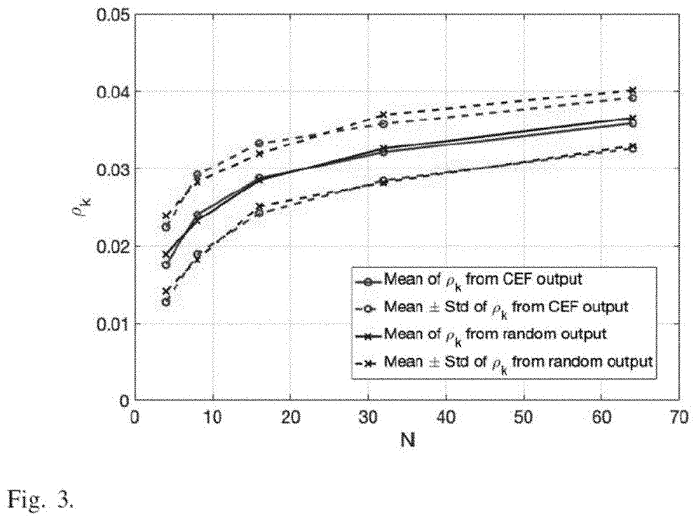

For a different k, there is a different realization of Q_{k,1}, . . . , Q_{k,N}. Hence, ρₖ changes with k. Shown in FIG. 3 are the mean and mean±deviation of ρₖ and ρ*ₖ versus N subject to η_{k,x}<2.5. We used 10000×100 realizations of x and {Q_{k,1}, . . . , Q_{k,N}}. We see that ρₖ and ρ*ₖ, have virtually the same mean and deviation. (Without the constraint η_{k,x}<2.5, ρₖ and ρ*ₖ match even better with each other.)

C. Difference Between Input and Output Distributions

To show that the SVD-CEF is entropy-preserving at least approximately, demonstrated below is that uₖ for all k have a near-zero linear correlation among themselves, and each uₖ is nearly uniformly distributed on S^{N-1}(1) when x is uniformly distributed on S^{N-1}(1).

When Q_{k,l} for all k and l are independent random unitary matrices, uₖ and uₘ for k≠m are independent of each other and ε_{Q}(uₖuₘ^{T})=0. Then for any typical realization of such Q_{k,l} for all k and l, and for any x, we should have

$$\frac{1}{K} {\sum }_{k = 1}^{K} {u}_{k} {u}_{k + m}^{T} \approx 0$$

for large K and any m≥1, which means a near-zero linear correlation among uₖ for all k.

To show that the distribution of uₖ for each k is also nearly uniform on S^{N-1}(1), we show below that for any k and any unit-norm vector v, the PDF p_{k,v}(x) of v^{T}uₖ subject to a fixed set of Q_{k,l} for all l and random x on S^{N-1}(1) is nearly the same as the PDF p(x) of any element in x. (The expression of p(x) is derived in (85) in Appendix B.) The distance between p(x) and p_{k,v}(x) can be measured by

$${D}_{k , v} = \int p ( x ) ln \frac{p ( x )}{{p}_{k , v} ( x )} dx \geq 0. \qquad ( 67 )$$

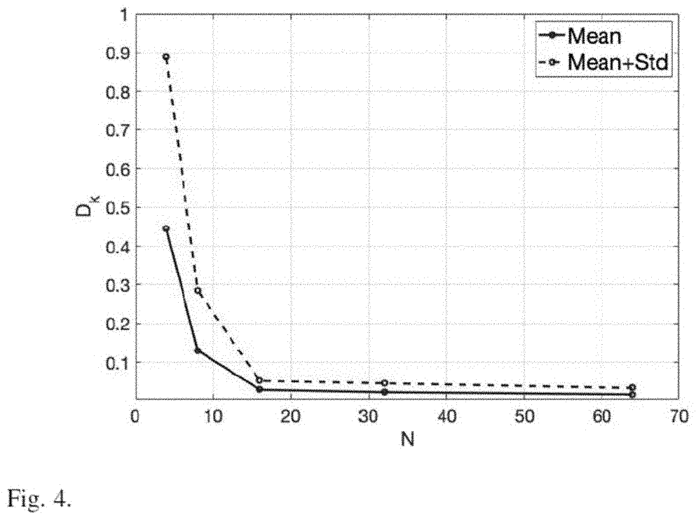

Clearly, D_{k,v} changes as k and v change. Shown in FIG. 4 are the mean and mean±deviation of D_{k,v} versus N subject to η_{k,x}<2.5. We used 50×1000×500 realizations of v, x and {Q_{k,1}, . . . , Q_{k,N}}. We see that D_{k,v} becomes very small as N increases. This means that for a large N, uₖ is (at least approximately) uniformly distributed on S^{N-1}(1) when x is uniformly distributed on S^{N-1}(1). (Without the constraint η_{k,x}<2.5, D_{k,v} versus N has a similar pattern but is somewhat smaller.)

### VII. CONCLUSION

Provided herein is a development of continuous encryption functions (CEF) that transcend the boundaries of wireless network science and biometric data science. The development of CEF is critically important for physical layer encryption of wireless communications and biometric template security for online Internet applications. Described are the important properties that a CEF should have and reviewed some prior developments of CEF-related functions. In particular, demonstrated herein are that the dynamic random projection method and the index-of-max hashing algorithm 1 are not hard to invert, and the index-of-max hashing algorithm 2 (IoM-2) is also not as hard to invert as it was thought to be. Also introduced is a new family of nonlinear CEF called SVD-CEF, which is shown to be much harder to invert than IoM-2. Presented herein are statistical analyses and simulation results, which support that the output of SVD-CEF has a good level of robustness against perturbations on the input, and the output elements at different instants have a near-zero correlation among themselves and with the input elements, and the statistical distribution of the output at any instant is nearly the same as that of the input. These results seem to suggest that SVD-CEF has all of the desired properties of CEF. However, unlike the unitary random projection discussed in section II-C above which has a unit ratio of output perturbation versus input perturbation, the SVD-CEF has a random ratio with its mean around 1.5 as shown in FIG. 1. This seems a necessary cost for the hard-to-invert property in the absence of a strong secret key.

An example of physical layer encryption using SVD-CEF is shown in Appendix C. It should be noted that physical layer encryption of wireless communications substantially differs from the classic two-step approach where the estimates x_{A} and x_{B} of x are first used to produce a secret key Sₓ via secret key generation [11]-[12], and then the secret key Sₓ is used for encryption at the network layer via discrete encryption functions [13]-[14].

### APPENDIX

A. Attack of SVD-CEF via EVD Equilibrium in X

Below, provided are details of an attack algorithm based on (54). Similar attack algorithms developed from (53) and (55) are omitted. An earlier result was also reported in [2].

It is easy to verify that X=αI_{N}+(1−α)xx^{T} with any −∞<α<∞ is a solution to the following

$$( {\sum }_{l = 1}^{N} {Q}_{k , l} {XQ}_{k , l}^{T} ) {u}_{k , x , 1} = {c}_{k , x , 1} {u}_{k , x , 1} \qquad ( 68 )$$

where c_{k,x,1}=α+(1−α)σ_{k,X}²₁. The expression (68) is more precise and more revealing than (54) for the desired unknown matrix X.

To ensure that u_{k,x,1} from (68) is unique, it is sufficient and necessary to find a X with the above structure and 1−α≠0. To ensure 1−α≠0, assume that x₁x₂≠0 where x₁ and x₂ are the first two elements of x. Then add the following constraint:

(X)_{1,2}=(X)_{2,1}=1 (69)

which is in addition to the previous condition Tr(X)=1. Now for the expected solution structure X=αI_{N}+(1−α)xx^{T}, we have

$$1 - α = \frac{1}{{x}_{1} {x}_{2}} \neq 0.$$

Note that c_{k,x,1} in (68) is either the largest or the smallest eigenvalue of Σₗ₌₁^{N} Q_{k,l} XQ_{k,l}^{T} corresponding to whether 1−α is positive or negative.

To develop the Newton's algorithm, now take the differentiation of (68) to yield

$$( {\sum }_{l = 1}^{N} {Q}_{k , l} \partial {XQ}_{k , l}^{T} ) {u}_{k} + ( {\sum }_{l = 1}^{N} {Q}_{k , l} {XQ}_{k , l}^{T} ) \partial {u}_{k} = \partial {c}_{k} {u}_{k} + {c}_{k} \partial {u}_{k} \qquad ( 70 )$$

where we have used uₖ=u_{k,x,1} and cₖ=c_{k,x,1} for convenience. The first term is equivalent to \tilde{Q}ₖ∂x̅ with \tilde{Q}ₖ=(Σₗ₌₁^{N}uₖ^{T}Q_{k,l}⊕Q_{k,l}) and \tilde{x}=vec(X). (For basics of matrix differentiation, see [16].)

Since X=X^{T}, there are repeated entries in \tilde{x}. We can write \tilde{x}=[\tilde{x}₁^{T}, . . . , \tilde{x}_{N}^{T}]^{T} with \tilde{x}ₙ=[\tilde{x}_{n,1}, . . . , \tilde{x}_{n,N}]^{T} and \tilde{x}_{i,j}=\tilde{x}_{j,i} for all i≠j. Let \tilde{x} be the vectorized form of the lower triangular part of X. Then it follows that

\tilde{Q}ₖ∂\tilde{x}=\hat{Q}ₖ∂\hat{x} (71)

where \hat{Q}ₖ is a compressed form of \tilde{Q}ₖ as follows. Let \tilde{Q}ₖ=[\tilde{Q}_{k,1}, . . . \tilde{Q}_{k,N}] with \tilde{Q}_{k,n}=[\tilde{q}_{k,n,l}, . . . , \tilde{q}_{k,n,N}]. For all 1≤i<j≤N, replace \tilde{q}_{k,i,j} by \tilde{q}_{k,j,i}, and then drop \tilde{q}_{k,j,i}. The resulting matrix is \hat{Q}ₖ.

The differential of Tr(X)=1 is Tr(∂X)=0 or equivalently t^{T}∂\hat{x}=0 where t^{T}=[t₁^{T}, . . . t_{N}^{T}] and tₙ^{T}=[1, 0_{1×(N . . . n)}]^{T}.

Combining the above for all k along with uₖ^{T}∂uₖ=0 (due to the norm constraint ∥uₖ∥²=1) for all k, we have

$${A}_{x} \partial \hat{x} + {A}_{u} \partial u + {A}_{z} \partial z = 0 \qquad ( 72 )$$

$$where$$

$${A}_{x} = [ \begin{matrix}{t}^{T} \\ {\hat{Q}}_{1} \\ … \\ {\hat{Q}}_{K} \\ {0}_{K \times \frac{1}{2} N ( N + 1 )}\end{matrix} ] \qquad ( 73 )$$

$${A}_{u} = [ \begin{matrix}{0}_{1 \times N K} \\ diag ( {G}_{1 , x} , … , {G}_{K , x} ) \\ diag ( {u}_{1}^{T} , … , {u}_{K}^{T} )\end{matrix} ] , \qquad ( 74 )$$

$${A}_{2} = [ \begin{matrix}{0}_{1} \times K \\ - diag ( {u}_{1} , … , {u}_{K} \\ {0}_{K \times K}\end{matrix} ] \qquad ( 75 )$$

$$with {G}^{k , x} = {M}_{k , x} {M}_{k , x}^{T} - {c}_{k} {I}_{M} .$$

Now partition u into two parts: uₐ (known) and u_{b} (unknown). Also partition Aᵤ into A_{u,a}, and A_{u,b} such that Aᵤ∂u=A_{u,a}∂uₐ+A_{u,b}∂u_{b}. Since (X)_{1,2}=(X)_{2,1}=1, also let \hat{z}₀ be \hat{x} with its second element removed, and A_{x,0} be Aₓ with its second column removed. It follows from (72) that

A∂a+B∂b=0 (76)

where a=uₐ, b=[\hat{x}₀^{T}, u_{b}^{T}, z^{T}]^{T}, A=A_{u,a}, B=[Aₓ, 0, A_{u,b}, A_{z}].

Based on (76), the Newton's algorithm is

$$[ \begin{matrix}{\hat{x}}_{0}^{( i + 1 )} \\ *\end{matrix} ] = [ \begin{matrix}{\hat{x}}_{0}^{( i )} \\ *\end{matrix} ] - {η ( {B}^{T} B )}^{- 1} {B}^{T} A ( {u}_{a} - {u}_{a}^{( i )} ) \qquad ( 77 )$$

where the terms associated with * are not needed, u_{z}⁽ⁱ⁾ is the ith-step “estimate” of the known vector uₐ (through forward (i) computation) based on the i-step estimate \hat{x}₀⁽ⁱ⁾ of the unknown vector \hat{x}₀. This algorithm requires

$$NyK {\geq }^{0} \frac{1}{2} N ( N + 1 ) - 1$$

in order for B to have full column rank.

For a random initialization around X, we can let X′=(1−β)X+βW where W is a symmetric random matrix with Tr(W)=1. Furthermore, (W)_{1,2}=(W)_{2,1} is such that (X′)_{1,2}=(V)_{2,1}=1. Keep in mind that at every step of iteration, keep (X⁽ⁱ⁾)_{1,2}=(X⁽ⁱ⁾)_{2,1}=1.

Upon convergence of X, we can also update x as follows. Let the eigenvalue decomposition of X be X=Σᵢ₌₁^{N}λᵢeᵢeᵢ^{T} where λ₁>λ₂> . . . >λ_{N}. Then the update of x is given by e₁ if 1−α>0 or by e_{N} if 1−α<0. With each renewed x, there are a renewed α and hence a renewed X (i.e., by setting X=αI+(1−α)xx^{T} with

$$1 - α = \frac{1}{x \vert {x}_{2} )} .$$

Using the new X as the initialization, we can continue the search using (77).

The performance of the algorithm (77) is discussed in section V-B.

B. Distributions of Elements of a Uniformly Random Vector on Sphere

Let x be uniformly random on Sⁿ⁻¹(r). This vector can be parameterized as follows:

$$\begin{matrix}{x}_{1} = r cos {θ}_{1} \\ {x}_{2} = r sin {θ}_{1} cos {θ}_{2} \\ … \\ {x}_{n - 1} = r sin {θ}_{1} … sin {θ}_{n - 2} cos {θ}_{n - 1} \\ {x}_{n} = r sin {θ}_{1} … sin {θ}_{n - 2} sin {θ}_{n} - 1\end{matrix}$$

where 0<θᵢ≤π for i=1, . . . , n−2, and 0<θₙ₋₁≤2π. According to Theorem 2.1.3 in [18], the differential of the surface area on Sⁿ⁻¹(r) is

dSⁿ⁻¹(r)=rⁿ⁻¹ sinⁿ⁻²θ₁ sinⁿ⁻³θ₂ . . . sin θₙ₋₂dθ₁ . . . dθₙ₋₁ (78)

### Further,

$${\int }_{{S}^{n - 1} ( r )} {dS}^{n - 1} ( r ) = \vert {S}^{n - 1} ( r ) \vert = \frac{2 {π}^{n / 2}}{Γ ( \frac{n}{2} )} {r}^{n - 1} .$$

### Hence, the PDF of x is

$${f}_{x} ( x ) = \frac{1}{\vert {S}^{n - 1} ( r ) \vert} . \qquad ( 79 )$$

1) Distribution of one element in x: We can rewrite

∫ₛ_{^{n−1}}₍ᵣ₎ƒₓ(x)dSⁿ⁻¹(r)=1

as

∫_{θ}_{₁}[∫ₛ_{^{n−2}}_{(r sin θ}_{₁}₎ƒₓ(x)rdSⁿ⁻²(r sin θ₁)]dθ₁=1 (80)

or equivalently

$${\int }_{{θ}_{1}} [ \frac{{S}^{n - 2} ( r sin {θ}_{1} ) \vert}{\vert {S}^{n - 1} ( r ) \vert} r ] d {θ}_{1} = 1. \qquad ( 81 )$$

### Hence the PDF of θ₁ is

$${f}_{{θ}_{1}} ( {θ}_{1} ) = \frac{\vert {S}^{n - 2} ( r sin {θ}_{1} ) \vert}{\vert {S}^{n - 1} ( r ) \vert} r . \qquad ( 82 )$$

To find the PDF of x₁=r cos θ₁, we have

$${f}_{{x}_{1}} ( {x}_{1} ) = {f}_{θ , 1} ( {θ}_{1} ) \frac{1}{\vert \frac{{dx}_{1}}{d {θ}_{1}} \vert} = \frac{{f}_{θ \text{.1}} ( {θ}_{1} )}{\vert r sin {θ}_{1} \vert} \qquad ( 83 )$$

where r sin θ₁=√r²−x₁². Therefore, combining all the previous results yields

$${f}_{{x}_{1}} ( {x}_{1} ) = \frac{Γ ( \frac{n}{2} )}{\sqrt{π} Γ ( \frac{n - 1}{2} )} \frac{{( {r}^{2} - {x}_{1}^{2} )}^{\frac{n - 3}{2}}}{{r}^{n - 2}} \qquad ( 84 )$$

where −r<x₁≤r.

If r=1, we have

$${f}_{{x}_{1}} ( {x}_{1} ) = \frac{Γ ( \frac{n}{2} )}{\sqrt{π} Γ ( \frac{n - 1}{2} )} {( 1 - {x}_{1}^{2} )}^{\frac{n - 3}{2}} \qquad ( 85 )$$

where −1≤x₁≤1. This is the PDF p(x) in section VI-C.

Due to symmetry, xᵢ for any i has the same PDF as x₁. Also note that if n=3, ƒₓ₁(x) is a uniform distribution.

2) Joint Distribution of Two Elements in x: We now consider a pair of elements in x.

It follows from ∫ₛ_{^{n−1}}₍ᵣ₎ ƒₓ(x)dSⁿ⁻¹(r)=1 that

∫_{θ}_{₁}∫_{θ}_{₂}[∫ₛ_{^{n−3}}_{(r sin θ}_{₁}_{sin θ}_{₂}₎ƒₓ(θ₁, . . . ,θₙ₋₁)r² sin θ₁

dSⁿ⁻¹(r sin θ₁ sin θ₂)]dθ₁dθ₂=1 (86)

or equivalently

$${\int }_{{θ}_{1}} {\int }_{{θ}_{2}} [ \frac{\vert {S}^{n - 3} ( r sin {θ}_{1} sin {θ}_{2} ) \vert}{\vert {S}^{n - 1} ( r ) \vert} {r}^{2} sin {θ}_{1} ] d {θ}_{1} d {θ}_{2} = 1. \qquad ( 87 )$$

Therefore, the PDF of θ₁ and θ₂ is

$${f}_{{θ}_{1} , {θ}_{2}} ( {θ}_{1} , {θ}_{2} ) = \frac{\vert {S}^{n - 3} ( r sin {θ}_{1} sin {θ}_{2} ) \vert}{\vert {S}^{n - 1} ( r ) \vert} {r}^{2} sin {θ}_{1} . \qquad ( 88 )$$

To derive the PDF of x₁ and x₂, recall x₁=r cos θ₁ and x₂=r sin θ₁ cos θ₂. Then dx₁=−r sin θ₁dθ₁ and dx₂=r cos θ₁ cos θ₂dθ₁−r sin θ₁ sin θ₂dθ₂. The exterior product of dx₁ and dx₂ (see [18] for exterior product) is

dx₁dx₂=r² sine θ₁ sin θ_{2d}θ_{1d}θ₂. (89)

Hence, the PDF of x₁ and x₂ is

$${f}_{{x}_{1} , {x}_{2}} ( {x}_{1} , {x}_{2} ) = \frac{{f}_{{θ}_{1} , {θ}_{2}} ( {θ}_{i} , {θ}_{2} )}{{r}^{2} {sin}^{2} {θ}_{1} sin {θ}_{2}} = \frac{\vert {S}^{n - 3} ( {r}^{′} ) \vert}{\vert {S}^{n - 1} ( r ) \vert} \frac{r}{{r}^{′}} \qquad ( 90 )$$

where r^{j}=r sin θ₁ sin θ₂=\sqrt{r²−x₁²−x₂²}. We see that ƒ_{x1,x2}(x₁,x₂) is circularly distributed and hence the phase θₓ of x₁+jx₂ is uniformly distributed within (−π,π], i.e., −π<θₓ≤π.

From symmetry, the phase of a complex number constructed from any two elements in x is uniform within (−π,π].

C. Physical Layer Encryption

Examples of physical layer encryption are available in [1][2]. Shown below is another example. Assume that nodes A and B have obtained respectively the estimates x_{A} and x_{B} of a “shared” secret feature vector x. Nodes A and B execute the same algorithm to compute the same SVD-CEF to obtain respectively φ_{A,k} and φ_{B,k}. Here φ_{A,k} is the phase of the first (or any) two elements of the principal eigenvector uₖ of M_{k,x} with x replaced by x_{A}. And φ_{B,k} is obtained similarly with x replaced by x_{B}. While both φ_{A,k} and φ_{B,k} are invariant to the sign and amplitude of x_{A} and x_{B} respectively, the former two are generally close to each other as long as the latter two are close to each other.

From the analysis shown in Appendix B2 and the results from section VI-C, each of the continuous variables φ_{A,k} and φ_{B,k} is uniformly distributed between −π and π as k changes and/or as x varies uniformly on S^{N-1}(1).

Assume the M-ary phase-shift-keying (M-PSK) modulation. The kth transmitted symbol from node A can be encrypted at the physical layer to have the form sₖ=e^{jθk+jφA,k} where θₖ is an information-carrying discrete phase from the M-PSK constellation. Accordingly, node B can perform decryption at the physical layer to obtain sₖ=sₖe^{jφB,k}e^{jθk+jφA,k-jφB,k}. Provided that φ_{A,k}-φ_{B,k} is small compared to the spacing of θₖ, the information in θₖ can be transmitted reliably from node A to node B (also securely against adversary who does not know anything about x). The spacing of θₖ or equivalently the data rate between the nodes subject to a given power can be dynamically adjusted via packet error detection coding, which is automatic in response to the actual levels of the channel noise and the phase error φ_{A,k}-φ_{B,k}.

As discussed in section VI-A1 above, node A can reduce the phase error by dropping Q_{k,1}, . . . , Q_{k,N} for which η_{k,x} exceeds a threshold. To inform node B of the corresponding values of k, node A can simply transmit a null symbol for each of these symbol instants. With P_{good} not far from one, the loss of spectral efficiency of a physical-layer encrypted packet (without use of any public channel) is not significant.

Although the disclosed examples have been fully described with reference to the accompanying drawings, it is to be noted that various changes and modifications will become apparent to those skilled in the art. For example, elements of one or more implementations may be combined, deleted, modified, or supplemented to form further implementations. Such changes and modifications are to be understood as being included within the scope of the disclosed examples as defined by the appended claims.

### REFERENCES

[1] Y. Hua, “Reliable and secure transmissions for future networks,” IEEE ICASSP′2020, pp. 2560-2564, May 2020.
[2] Y. Hua and A. Maksud, “Unconditional secrecy and computational complexity against wireless eavesdropping,” IEEE SPAWC'2020, 5 pp., May 2020.
[3] A. K. Jain, K. Nandakumar, and A. Nagar, “Biometric template security”, EURASIP Journal on Advances in Signal Processing, 2008.
[4] D. V. M. Patel, N. K. Ratha, and R. Chellappa, “Cancelable Biometrics”, IEEE Signal Processing Magazine, September, 2015.
[5] A. B. J. Teoh, C. T. Young, “Cancelable biometrics realization with multispace random projections,” IEEE Transactions on Systems, Man and Cybernetics, Vol. 37, No. 5, pp. 1096-1106, October 2007.
[6] E. B. Yang, D. Hartung, K. Simoens and C. Busch, “Dynamic random projection for biometric template protection, Proc. IEEE Int. Conf. Biometrics: Theory Applications and Systems, September 2010, pp. 17.
[7] D. Grigoriev and S. Nikolenko, “Continuous hard-to-invert functions and biometric authentication,” Groups 44(1):19-32, May 2012.
[8] Z. Jin, Y.-L. Lai, J. Y. Hwang, S. Kim, A. B. J. Teoh “Ranking Based Locality Sensitive Hashing Enabled Cancelable Biometrics: Index-of-Max Hashing”, IEEE Transactions on Information Forensic and Security, Volume: 13, Issue: 2, February 2018.
[9] J. K. Pillai, V. M. Patel, R. Chellappa, and N. K. Ratha, “Secure and robust Iris recognition using random projections and sparse representation,” IEEE Transactions on Pattern Analysis and Machine Intelligence, Vol. 33, No. 9, September 2011.
[10] S. Kirchgasser, C. Kauba, Y.-L. Lai, J. Zhe, A. Uhl, “Finger Vein Template Protection Based on Alignment-Robust Feature Description and Index-of-Maximum Hashing,” IEEE Transactions on Biometrics, Behavior, and Identity Science, Vol. 2, No. 4, pp. 337-349, October 2020.
[11] U. M. Maurer, “Secret Key Agreement by Public Discussion from Common Information,” IEEE Trans Information Theory, May 1993.
[12] H. V. Poor and R. F. Schaefer, “Wireless physical layer security”, PNAS, Vol. 114, no. 1, pp. 19-26, Jan. 3, 2017.
[13] L. A. Levin, “The tale of one-way functions,” arXiv:cs/0012023v5, August 2003.
[14] J. Katz and Y. Lindell, Introduction to Modern Cryptography, 2nd Ed., CRC, 2015.
[15] G. H. Golub and C. F. Van Loan, Matrix Computations, John Hopkins University Press, 1983.
[16] J. R. Magnus and H. Neudecker, Matrix Differential Calculus with Applications in Statistics and Econometrics, Wiley, 2002.
[17] A. Greenbaum, R.-C. Li, M. L. Overton, “First-order perturbation theory for eigenvalues and eigenvectors,” arXiv:1903.00785v2, 2019.
[18] R. J. Muirhead, Aspects of Multivariate Statistical Theory, Wiley, 1982.

1. A communication network comprising:
a first communication node configured for, based on a first association with a vector, encrypting information to be transmitted;
a transmitter circuitry configured for transmitting the encrypted information;
a receiver circuitry configured for receiving the transmitted encrypted information;
a second communication node configured for, based on a second association with the vector, decrypting the received encrypted information.

2. The communication network of claim 1,
wherein:
the vector is a physical-layer feature vector x,
the first association with the vector is a first estimate x_{A} of the physical-layer feature vector x, the first communication node configured for, based on the first estimate x_{A}, encrypting the information to be transmitted, and
the second association with the vector is a second estimate x_{B} of the physical-layer feature vector x, the second communication node configured for, based on the second estimate x_{B}, decrypting the received encrypted information.

3. The communication network of claim 2, wherein the first communication node is configured for, based on the first estimate x_{A}, performing physical layer encrypting of information to be transmitted over wireless communications.

4. The communication network of claim 2, wherein the second communication node is configured for, based on the second estimate x_{B}, performing physical layer decrypting of the encrypted information received over wireless communications.

5. The communication network of claim 2, wherein the encrypted information is in a quantized form.

6. The communication network of claim 2, wherein the decrypted information is in a quantized form.

7. The communication network of claim 2, wherein the vector is a secret physical-layer feature vector.

8. The communication network of claim 1, wherein the first communication node is configured for, based on a linear encryption function, encrypting the information to be transmitted.

9. The communication network of claim 8, wherein the linear encryption function is based on a secret key S that has a large number N_{S} of binary bits in the secret key S.

10. The communication network of claim 8, wherein the linear encryption function is based on a composite key S that is based on an external key Sₑ and a key Sₓ generated from the vector.

11. The communication network of claim 8,
wherein:
the vector is a common feature vector,
the first association with the vector is a first observation x of the common feature vector, the first communication node configured for, based on the first observation x, encrypting the information to be transmitted,
the second association with the vector is a second observation x′ of the common feature vector, the second communication node configured for, based on the second observation x′, decrypting the received encrypted information, and
the linear encryption function is based on a secret key S based on the first observation x and the second observation x′.

12. The communication network of claim 1, wherein the first communication node is configured for, based on a nonlinear encryption function, encrypting the information to be transmitted.

13. The communication network of claim 12, wherein the nonlinear encryption function has an output that is based on a singular value decomposition of an input.

14. The communication network of claim 13,
wherein:
the input is an input vector x,
M_{k,x} is a matrix, for index k, comprising elements that result from a random modulation of the input vector x,
the output is an output vector y, and
individual elements of the output vector y is based on a component of the singular value decomposition of M_{k,x} for a value of the index k.

15. The communication network of claim 13,
wherein:
the first communication node is configured for executing an algorithm to determine the nonlinear encryption function based on a singular value decomposition, and
the second communication node is configured for executing the algorithm to determine the nonlinear encryption function based on a singular value decomposition.

16. A communication node comprising:
an encryption circuitry configured for, based on an association with a vector, encrypting information to be transmitted;
a transmitter circuitry configured for transmitting the encrypted information.

17. The communication node of claim 16, wherein the communication node is configured for, based on a nonlinear encryption function, encrypting the information to be transmitted.

18. The communication node of claim 17, wherein the nonlinear encryption function has an output that is based on a singular value decomposition of an input.

19. A communication node comprising:
a receiver circuitry configured for receiving encrypted information;
a decryption circuitry configured for, based on an association with a vector, decrypting the received encrypted information.

20. The communication node of claim 19, wherein the communication node is configured for, based on a nonlinear encryption function, decrypting the received encrypted information.

21. The communication node of claim 20, wherein the nonlinear encryption function has an output that is based on a singular value decomposition of an input.

22. A method comprising:
encrypting, based on a first association with a vector, information to be transmitted;
transmitting the encrypted information;
receiving the transmitted encrypted information; and
decrypting, based on a second association with the vector, the received encrypted information.
